(19) United States
(12) Patent Application Publication
(10) Pub. No.: US 2020/0328483 A1
(43) Pub. Date: Oct. 15, 2020

(54) BATTERIE UND VERWENDUNG EINER SOLCHEN

(71) Applicant: Robert Bosch GmbH, Stuttgart (DE)

(72) Inventors: Benjamin Kopp, Remseck Am Neckar (DE); Markus Schmitt, Tamm (DE)

(21) Appl. No.: 16/848,948

(22) Filed: Apr. 15, 2020

(30) Foreign Application Priority Data
Apr. 15, 2019 (DE) 102019205388.2

(51) Int. Cl. H01M 10/613; H01M 10/647; H01M 10/6568; H01M 10/6561

(52) U.S. Cl. CPC H01M 10/613; H01M 10/647; H01M 2220/20; H01M 10/6561; H01M 10/6568

(57) ABSTRACT

The invention relates to a battery comprising a first housing element (2) and a second housing element (3), which jointly form an inner chamber (5) for receiving a battery module (6), wherein a plurality of battery cells (7) of the battery module (6) is arranged in the inner chamber (5), said battery cells being connected in an electrically conductive manner in series and/or in parallel to one another and wherein furthermore at least one electrical component (8) and/or at least one electronic component (9) of the battery module (6) are arranged in the inner chamber (5), wherein the first housing element (2) forms a first temperature control structure (101) on a face that is remote from the inner chamber (5) and in particular from the second housing element (3), wherein the second housing element (3) is connected to a third housing element (4) on a face that is remote from the inner chamber (5) and in particular from the first housing element (2) while forming a second temperature control chamber (112) through which temperature control fluid may flow, wherein the third housing element (4) receives an electrical voltage convertor (12), in particular a DC convertor (120).

### BACKGROUND OF THE INVENTION

The invention is based on a battery. Subject matter of the present invention is also the use of such a battery.

It is known from the prior art that a battery module has a plurality of individual battery cells that each comprise a positive voltage tap-off and a negative voltage tap-off, wherein in order to connect the plurality of battery cells to one another in an electrically conductive manner in series and/or in parallel the respective voltage tap-offs are connected to one another in an electrically conductive manner and consequently connected together to form the battery module. Battery modules for their part are connected to batteries or to battery systems. On account of a multiplicity of possible different installation spaces in vehicles, variable module sizes are desired in order to be able to make optimal use of the available installation space.

Furthermore, the battery cells of a battery module, such as for example lithium ion battery cells or lithium polymer battery cells, heat up during operation on account of chemical conversion processes and on account of their electrical resistance as battery cells are discharged or charged. In particular, these processes have comparable characteristics in the case of a comparably quick discharge or charging procedure. The greater the capacity of a battery or a battery module, the more heat is produced and consequently the greater the requirements with regard to an efficient temperature control system. In order to increase the safety and reliability of a battery module and also to ensure the efficiency of the battery cells, the battery cells of a battery module need to warm up and cool down in order for them to be able to operate as far as possible in a determined temperature range, so that it is possible by way of example to prevent increased aging behavior or a degradation of the cell chemistry.

However, the battery cells primarily need to cool down.

By way of example, it is possible to control the temperature of the battery, in other words warm up or cool down the battery, by way of a fluid temperature control procedure using a water/glycol mixture. In this case, this mixture is directed through cooling plates that are arranged below the battery module. The cooling plate may be connected in this case to a corresponding component of a cooling circuit.

### SUMMARY OF THE INVENTION

A battery according to the invention offers the advantage that it is possible to adapt the procedure of controlling the temperature of individual components of the battery to their respective requirements. In particular, it is possible by way of a configuration of two temperature control chambers to adapt and optimize the procedure to meet the requirements with regard to controlling the temperature of a plurality of battery cells and of components of the power electronics separately from one another.

For this purpose, a battery is provided in accordance with the invention. The battery comprises a first housing element and a second housing element. The first housing element and the second housing element jointly form an inner chamber for receiving a battery module. In this case, a plurality of battery cells of the battery module is arranged in the inner chamber. The plurality of battery cells is connected in an electrically conductive manner in series and/or in parallel to one another. Furthermore, a first element of a battery control system is arranged in the inner chamber.

The first housing element forms a first temperature control structure on a face that is remote from the inner chamber. In particular, furthermore the first temperature control structure is formed on a face that is remote from the second housing element.

The second housing element is connected on a face that is remote from the inner chamber to a third housing element. In this case, the second housing element and the third housing element jointly form a second temperature control chamber through which temperature control fluid may flow. In particular, the second housing element is connected on a face that is remote from the first housing element to the third housing element.

In this case, the third housing element receives a second element of the battery control system.

In particular, one embodiment in accordance with the invention of the battery offers the advantage that components that convey the temperature control fluid are arranged outside the inner chamber, with the result that in the event of leakages the temperature control fluid may not pass to the battery cells, as a result of which it is possible to increase safety and reliability. In addition, it is possible to cool the individual components in an efficient manner since comparably short thermal paths are produced.

It is advantageous if the first element of the battery control system comprises at least one electrical component and/or at least one electronic component (9) of the battery module and that the second element of the battery control system is an electrical voltage convertor, in particular a DC convertor.

It is also advantageous if the second element of the battery control system comprises at least one electrical component and/or at least one electronic component of the battery module and that the second element of the battery control system is an electrical voltage convertor, in particular a DC convertor.

It is expedient if the first housing element, the second housing element and/or the third housing element are each embodied as die-cast housings. As a consequence, it is possible to provide a mechanically comparably stable configuration. In addition, it is consequently possible that regions that convey the temperature control fluid may be embodied within the die-cast components or are formed by way of connecting two die-cast components to one another, with the result that it is possible to forego additional cooling plates, heating elements or temperature control systems.

It is advantageous if the first housing element and the second housing element are connected to one another in a fluid-tight manner. In particular, a first sealing element is arranged between the first housing element and the second housing element. Consequently, an inner chamber of the battery is provided that is sealed in a fluid-tight manner. In particular, this renders it possible to protect the battery cells, the electrical component and/or the electronic components from external influences.

In accordance with a preferred aspect of the invention, the plurality of battery cells is embodied as prismatic battery cells. Prismatic battery cells comprise hereby a total of six side faces that are arranged in pairs lying opposite one another and parallel to one another. Furthermore, side faces that are arranged adjacent to one another are arranged at right angles with respect to one another. Overall, it is possible to provide a compact battery by way of using prismatic battery cells in a battery in accordance with the invention.

It is preferred if the electrical component of the battery module is a cell connector and/or a cable. Cell connectors are embodied so as to connect voltage tap-offs of battery cells in an electrically conductive manner in series and/or in parallel to one another. Cables are embodied so as to conduct electrical current from one component to another component.

It is preferred if the electronic component of the battery module is a switch, a safety element, a battery control system and/or a resistor.

It is possible by way of arranging the electrical component and/or the electronic component within the inner chamber of the battery to connect the plurality of battery cells of the battery module in an electrically conductive manner in series and/or in parallel to one another and also to open-loop control and closed-loop control the battery module.

In accordance with a preferred aspect of the invention, the at least one electronic component is integrated into a circuit board. This offers the advantage of a comparably compact configuration, the temperature of which is furthermore simple to control.

It is expedient if a covering element is arranged on the first housing element. In this case, the covering element and the first temperature control structure jointly form a first temperature control chamber through which temperature control fluid may flow. In this case, it is possible by way of example for the temperature control fluid, which is flowing directly in a thermally conductive manner from one of the first temperature control chambers, to flow around the temperature control structure.

This offers the advantage that the first temperature control structure may be adapted to the requirements with regard to controlling the temperature of the plurality of battery cells that are arranged in the inner chamber. In this case, it is possible to adjust the manner in which the temperature control procedure is adapted independently of the procedure of cooling the electrical component and/or the electronic component and also independently of the procedure of cooling the electrical voltage convertor. By way of example, the first temperature control structure may comprise flow disturbing elements or flow guiding elements that are only arranged at sites where on account of the required temperatures of the plurality of battery cells they may have a positive influence on the temperature control procedure. Furthermore, the remaining regions of the first temperature control chamber may be optimized with respect to the flow and loss of pressure. In particular, it is possible to forego a compromise between controlling the temperature of the plurality of battery cells and of the electrical component and/or the electronic component and also the electrical voltage convertor since it is possible to control the temperature of these components independently of one another.

It is preferred in this case that the covering element is connected to the first housing element in a material-bonded manner. In particular, the covering element may be welded or soldered to the first housing element. Furthermore, a second sealing element may be arranged between the first housing element and the covering element.

It is also preferred for it to be possible if the covering element is formed by the first housing element.

Overall, this offers the advantage that it is possible by way of such a configuration to prevent temperature control fluid from passing into the inner chamber to the plurality of battery cells if defects or leakage sites occur in the first temperature control chamber.

In an advantageous manner, the battery comprises a first connection and a second connection. The first connection is embodied in this case so as to convey the temperature control fluid to the battery and the second connection is embodied in this case so as to discharge the temperature control fluid from the battery.

In particular, the first connection and the second connector form an interface to a motor vehicle.

In accordance with a first aspect, the temperature control fluid may flow through the first temperature control fluid receiving facility and the second temperature control fluid receiving facility in series. In this case, the temperature control fluid flows by way of example initially through the first temperature control fluid receiving facility and subsequently through the second temperature control fluid receiving facility.

In accordance with a second aspect of the invention, the temperature control fluid may flow through the first temperature control fluid receiving facility and the second temperature control fluid receiving facility in parallel. In this case, after it has flowed through the first connection, the temperature control fluid is divided into a first part flow, which flows through the first temperature control fluid receiving facility, and a second part flow which flows through the second temperature control fluid receiving facility. The first part flow and the second part flow are rejoined after they have flowed through the respective temperature control chamber receiving facility and discharged from the battery by means of the second connection. It is possible hereby by way of example to minimize the pressure loss.

In particular, the first housing element and the second housing element and/or the third housing element hereby each comprise a temperature control fluid inlet and a temperature control fluid outlet. The respective temperature control fluid inlet is used so as to allow temperature control fluid into the first flow chamber or the second flow chamber and the respective temperature control fluid outlet is used so as to allow temperature control fluid to flow out from the first flow chamber or the second flow chamber. Furthermore, a temperature control fluid inlet and a temperature control fluid outlet may be connected to one another in a fluid-conducting manner with the result that temperature control fluids may flow between the first flow chamber and the second flow chamber or conversely.

By way of example, the temperature control fluid inlet of the second housing element and/or of the third housing element form the first connection of the battery with the result that temperature control fluid may flow into the second flow chamber. Furthermore, by way of example, the temperature control fluid outlet of the second housing element and/or the third housing element may be connected to the temperature control fluid inlet of the first housing element in a fluid-conducting manner with the result that temperature control fluid may first flow through the second flow chamber and subsequently through the first flow chamber, in other words a series through-flow connection is formed. In addition, by way of example, the temperature control fluid outlet of the first housing element may form the second connection of the battery with the result that hereby temperature control fluid may exit the first flow chamber.

By way of example, the temperature control fluid inlet of the first housing element may form the first connection of the battery with the result that hereby temperature control fluid may flow into the first flow chamber. Furthermore, by way of example, the temperature control fluid outlet of the first housing element may be connected in a fluid-conducting manner to the temperature control fluid inlet of the second housing element and/or of the third housing element with the result that temperature control fluid may first flow through the first flow chamber and subsequently through the second flow chamber, in other words a series through-flow connection is formed. In addition, by way of example, the temperature control fluid outlet of the second housing element and/or of the third housing element may form the second connection of the battery with the result that hereby temperature control fluid may exit the second flow chamber.

It is expedient if the second housing element forms a second temperature control structure and/or if the third housing element forms a third temperature control structure. As a consequence, it is possible to adapt the second temperature control structure and/or the third temperature control structure to the requirements with regard to cooling the electrical component and/or the electronic component and also the electrical voltage convertor. In particular, this adaption may be performed independently of the requirements with regard to the procedure of cooling the cells. The second temperature control structure and/or the third temperature control structure may be embodied by way of example as flow guiding elements or as flow disturbing elements, wherein the second temperature control structure and/or the third temperature control structure are arranged at such sites where a comparably intensive temperature control procedure is required. The other regions of the second temperature control chamber may be optimized with respect to pressure or the manner in which the flow is guided. In particular, it is possible to forego a compromise between controlling the temperature of the plurality of battery cells and of the electrical component and/or the electronic component and also the electrical voltage convertor since it is possible to control the temperature of these components independently of one another.

Furthermore, in this case a third sealing element may be arranged between the second housing element and the third housing element. By way of example, the second housing element and/or the third housing element may hereby form corresponding receiving facilities for the third sealing element, in which the sealing element may be arranged. By way of example, such a corresponding receiving facility may be configured as a sealing groove. By way of connecting the second housing element and the third housing element, the third sealing element may be accordingly pressed in so as to form a sealing arrangement. Consequently, the second temperature control chamber may be sealed accordingly with respect to an environment. In particular, it is hereby possible to prevent temperature control fluid passing into the inner chamber to the plurality of battery cells in the case of a possible leakage of the second temperature control chamber.

It is preferred that the first temperature control structure, the second temperature control structure and/or the third temperature control structure are each embodied as flow guiding elements, as flow disturbing elements or as flow limiting elements.

In particular, the first temperature control structure, the second temperature control structure and/or the third temperature control structure may each be formed by the corresponding die-cast housing.At this point, flow guiding elements are to be understood to be such elements that are arranged within a respective temperature control chamber and that are used to deflect a flow without creating a comparable increase in turbulence.

At this point, flow disturbing elements are to be understood to be such elements that are arranged within a respective temperature control chamber and that are used to increase the turbulence of a flow, in particular to create a transition from a laminar flow to a turbulent flow in order however to improve the manner in which heat is discharged.

At this point, flow limiting elements are to be understood to be such elements that mechanically limit the respective temperature control chamber.

In particular, it is to be noted that for this purpose the second temperature control structure and the third temperature control structure jointly may influence a temperature control fluid that is flowing through the second flow chamber.

It is of advantage if the plurality of battery cells is connected in a fluid-conducting manner to a first inner face of the inner chamber, wherein the first inner face is arranged directly adjacent to the first temperature control structure. In particular, in so doing a first thermal compensating element, such as by way of example a thermally conductive adhesive material, may be arranged between the plurality of battery cells and the inner face.

It is also advantageous if the electrical component and/or the electronic component is/are connected to a second inner face of the inner chamber in a thermally conductive manner, wherein the second inner face is arranged directly adjacent to the second temperature control chamber. In particular, in so doing a second thermal compensating element, such as by way of example a thermally conductive adhesive material or a so-called thermal interface material (TIM), may be arranged between the electrical component and/or the electronic component.

By way of example, it is possible by way of connecting a circuit board that comprises the electronic component to the second housing element, by way of example by means of screws, to form a reliable thermal conductive path. Overall, a comparably short thermal path is hereby created between a temperature control fluid, which is flowing through the second temperature control chamber, and the circuit board having a consequently comparably low thermal resistance.

Furthermore, it is advantageous if the electrical voltage convertor is connected in a thermally conductive manner to the third inner face of the third housing element, wherein the third inner face is arranged directly adjacent to the second temperature control chamber. In so doing, furthermore a third thermal compensating material, such as by way of example a thermally conductive adhesive material or a so-called thermal interface material (TIM), may be arranged between the electrical voltage convertor and the third inner face. It is possible by way of connecting, such as by way of example by means of screws, the electrical voltage convertor to the third housing element to form a reliable thermal conductive path. Overall, a comparably short thermal path is hereby created between a temperature control fluid, which is flowing through the second temperature control chamber, and the electrical voltage convertor having a consequently comparably low thermal resistance.

Subject matter of the present invention is also the use of an above-described battery in accordance with the invention so as to control the temperature and in particular to cool the plurality of battery cells, the electrical component and/or the electronic component and/or the electrical voltage convertor, wherein a temperature control fluid, which is in the form of a temperature control liquid or a temperature control gas, flows around the first temperature control structure or wherein the temperature control fluid that is in the form of a temperature control liquid flows through the second temperature control chamber.

### BRIEF DESCRIPTION OF THE DRAWINGS

Exemplary embodiments of the invention are illustrated in the drawings and further explained in the description below.

In the drawings:

FIG. 1 illustrates in a perspective view an embodiment in accordance with the invention of a battery,

FIG. 2 illustrates in a lateral view the embodiment in accordance with the invention of the battery according to FIG. 1,

FIG. 3 illustrates in a perspective view a bottom view of an embodiment of a first housing element of a battery in accordance with the invention,

FIG. 4 illustrates in a perspective view a plan view of the embodiment of the first housing element of the battery in accordance with the invention according to FIG. 3,

FIG. 5 illustrates in a perspective view a plan view of an embodiment of a second housing element of a battery in accordance with the invention,

FIG. 6 illustrates in a perspective view a bottom view of the embodiment of the second housing element of the battery in accordance with the invention according to FIG. 5,

FIG. 7 illustrates in a perspective view a bottom view of an embodiment of a third housing element of a battery in accordance with the invention,

FIG. 8 illustrates in a perspective view a plan view of the embodiment of the third housing element of the battery in accordance with the invention according to FIG. 8,

FIG. 9 illustrates in a perspective view a first exploded illustration of a section of a battery in accordance with the invention, and

FIG. 10 illustrates in a perspective view a second exploded illustration of a section of a battery in accordance with the invention.

### DETAILED DESCRIPTION

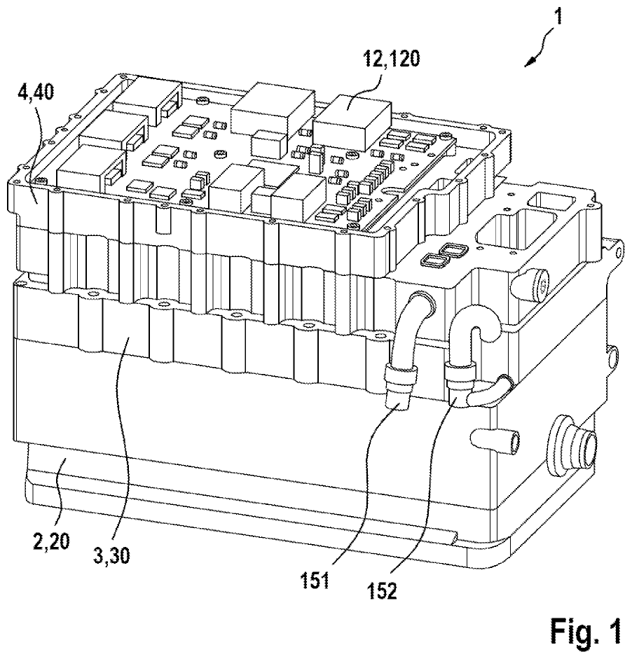

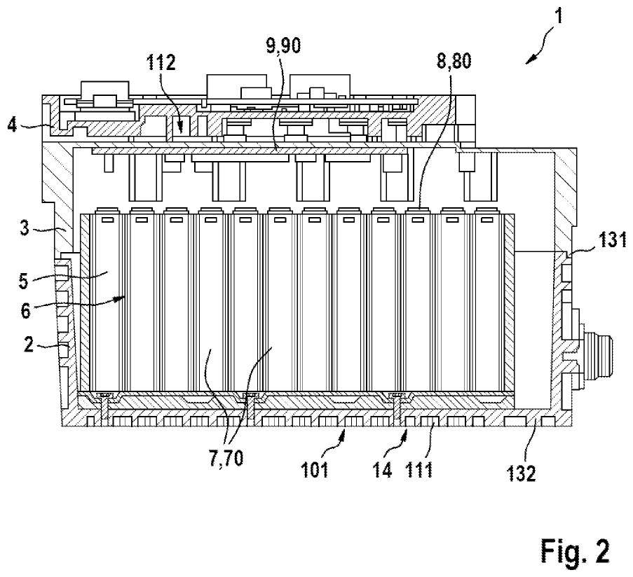

FIG. 1 illustrates in a perspective view an embodiment in accordance with the invention of a battery 1. FIG. 2 illustrates this embodiment in accordance with the invention of the battery 1 according to FIG. 1 in a lateral view. A joint description of FIGS. 1 and 2 is now provided.

The battery 1 comprises a first housing element 2, a second housing element 3 and a third housing element 4. According to the embodiment of the battery 1 illustrated in FIGS. 1 and 2, the first housing element 2 is embodied as a die-cast housing 20, the second housing element 3 is embodied as a die-cast housing 30 and the third housing element 4 is embodied as a die-cast housing 40.

The first housing element 2 and the second housing element 3 jointly form an inner chamber 5 for receiving a battery module 6. In particular, the inner chamber 5 and the battery module 6 are apparent in the sectional view according to FIG. 2. In particular, the first housing element 2 and the second housing element 3 are connected to one another in a fluid-tight manner. In particular, a first sealing element 131 is between the first housing element 2 and the second housing element 3. In particular, the first housing element 2 and the second housing element 3 may be connected to one another by way of screws.

A plurality of battery cells 7 is arranged in the inner chamber 5. The plurality of battery cells 7 of the battery module 6 is in this case connected in an electrically conductive manner in series and/or in parallel to one another. It is preferred, as is apparent in particular in FIG. 2, to embody the plurality of battery cells 7 as prismatic battery cells 70.

Furthermore, electrical components 8 of the battery module 6 and electronic components 9 of the battery module 6 are arranged in the inner chamber 5. By way of example, the electrical components 8 may be cell connectors 80 that connect the plurality of battery cells 7, 70 in an electrically conductive manner in series and/or parallel to one another. Furthermore, the electrical components 8 are cables that conduct electrical current. By way of example, the electronic components 9 of the battery module 6 may be switches, safety elements, battery control systems and/or resistors. In particular, it is preferred that the electronic components 9, as is apparent in FIG. 2, are integrated at least in part into a circuit board 90.

The first housing element 2 forms a first temperature control structure 101 on a face that is remote from the inner chamber 5. In particular in the case of the embodiment according to FIGS. 1 and 2, the first temperature control 101 is arranged on a face of the first housing element 2 that is remote from the second housing element 3. Furthermore, FIG. 2 also illustrates that a covering element 14 is arranged on the first housing element 2. In this case, the covering element 14 and the first housing element 2 jointly form a first temperature control chamber 111 through which temperature control fluid may flow. The first temperature control structure 101 is in this case arranged within the first temperature control chamber 111. In particular, the covering element 14 may be connected in a material-bonded manner to the first housing element 2. In this case, it is furthermore preferred that a second sealing element 132 is arranged between the first housing element 2 and the covering element 14.

The second housing element 3 is connected to the third housing element 4 on a face that is remote from the inner chamber 5. In particular, the second housing element 3 is connected to the third housing element 4 on a face that is remote from the first housing element 2. In this case, the second housing element 3 and the third housing element 4 are connected to one another while forming a second temperature control chamber 112 through which a temperature control fluid may flow.

The third housing element 4 receives in this case an electrical voltage convertor 12. In particular, the electrical voltage convertor 12 is a DC convertor 120.

Furthermore, FIG. 1 illustrates in particular that the battery 1 comprises a first connection 151 and a second connection 152. The first connection 151 is embodied in this case so as to guide temperature control fluid to the battery 1 and the second connection 152 is embodied in this case so as to discharge temperature control fluid from the battery 1. In this case, the temperature control fluid may flow through the battery 1 and in particular the first temperature control chamber 111 and the second temperature control chamber 112 in series or in parallel.

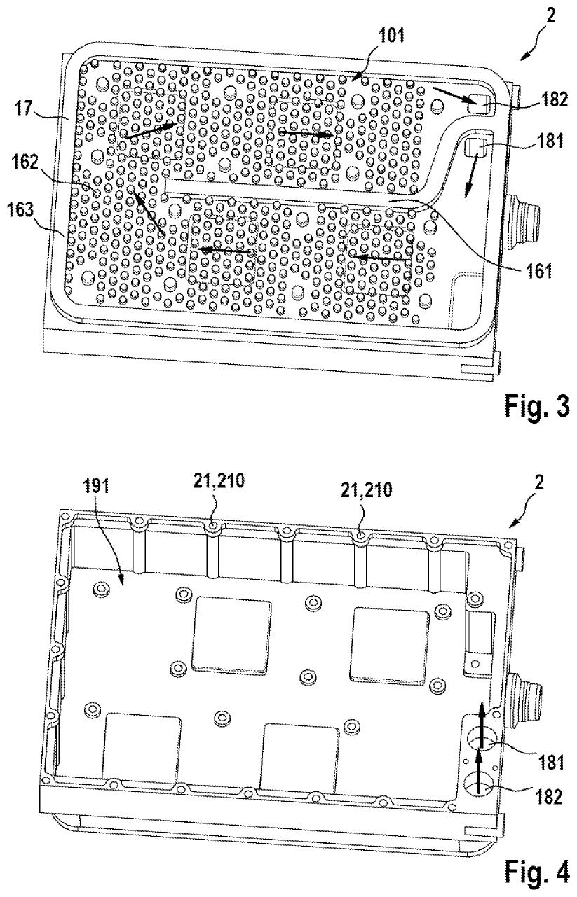

FIG. 3 illustrates in a perspective view a bottom view of an embodiment of a first housing element 2 of a battery 1 in accordance with the invention. FIG. 4 illustrates in a perspective view a plan view of the embodiment of the first housing element 2 of the battery 1 in accordance with the invention. The first housing element 2 is to be described now with reference to FIGS. 3 and 4 jointly.

FIG. 3 illustrates initially the first temperature control structure 101.

In this case, it is apparent that the first temperature control structure 101 comprises flow guiding elements 161, flow disturbing elements 162 and flow limiting elements 163. In this case, the temperature control structure 101 ensures a configuration of the flow direction that is indicated by arrows in the first temperature control chamber 111.

Furthermore, FIG. 3 also illustrates a connection site 17 for connecting the covering element 14 in a material-bonded manner.

Furthermore, FIGS. 3 and 4 also illustrate that the first housing element 2 has a temperature control fluid inlet 181 and a temperature control fluid outlet 182. The temperature control inlet 181 is embodied in this case so as to allow temperature control fluid to flow into the first flow chamber 111 and the temperature control fluid outlet 182 is embodied in this case so as to allow temperature control fluid to flow out of the first temperature control chamber 111.

A first inner face 191 of the inner chamber 5 is apparent in FIG. 4. The first inner face 191 is in this case directly adjacent to the first temperature control structure 101, which is also apparent in FIG. 2. In this case, in the case of an embodiment of a battery 1 in accordance with the invention, the plurality of battery cells 7 is connected in a thermally conductive manner to the first inner face 191 of the inner chamber 5. In particular, Peltier elements 26 that are to be explained below may also be connected thereto.

Furthermore, possible connecting elements 21 that are embodied as screw-connection points 210 so as to connect to the second housing element 3 are also apparent in FIG. 4.

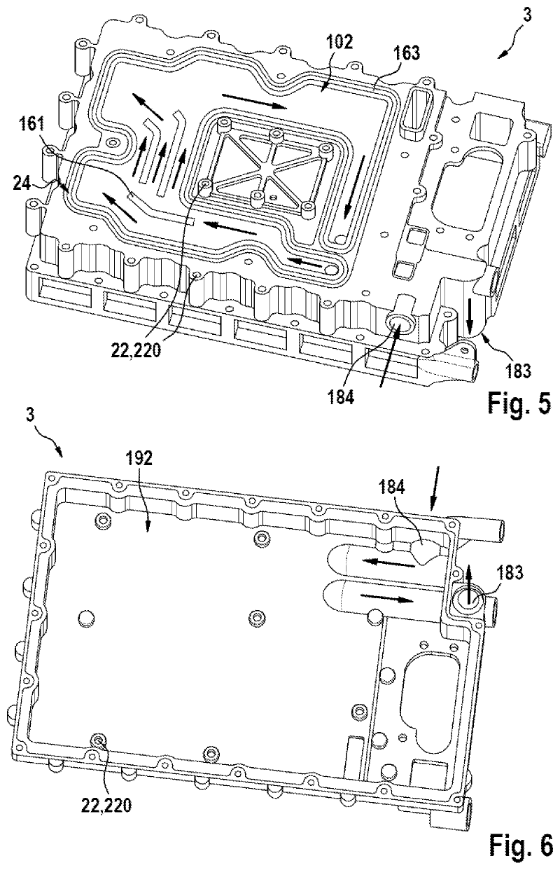

FIG. 5 illustrates in a perspective view a plan view of an embodiment of a second housing element 3 of a battery 1 in accordance with the invention. FIG. 6 illustrates in a perspective view a bottom view of the embodiment of the second housing element 3 of the battery 1 in accordance with the invention. The embodiment of the second housing element 3 is now to be described with reference to FIGS. 5 and 6 jointly.

It is initially apparent in FIG. 5 that the second housing element 3 forms a second temperature control structure 102. By way of example, the second temperature control 102 may comprise flow guiding elements 161 and flow limiting elements 163. In particular, the flow may be consequently guided as indicated by the arrows in the second temperature control chamber 112.

Furthermore, it is also apparent in FIG. 5 that the second housing element 3 forms a temperature control fluid inlet 183 and a temperature control fluid outlet 184. The temperature control fluid inlet 183 is embodied in this case so as to allow temperature control fluid to flow into the second temperature control chamber 112 and the temperature control fluid outlet 184 is embodied in this case so as to allow temperature control fluid to flow out of the second temperature control chamber 112.

The temperature control fluid inlet 183 of the second housing element 3 may be connected in a fluid-conducting manner by way of example to the temperature control fluid outlet 182 of the first housing element 2. As a consequence, temperature control fluid may first flow through the first temperature control chamber 111 and subsequently through the second temperature control chamber 112.

Furthermore, the temperature control fluid outlet 184 of the second housing element 3 may be connected by way of example in a fluid-conducting manner to the temperature control fluid inlet 181 of the first housing element 2. As a consequence, temperature control fluids may first flow through the second temperature control chamber 112 and subsequently through the first temperature control chamber 111.

FIG. 6 illustrates a second inner face 192 of the inner chamber 5. The second inner face 192 is in this case arranged directly adjacent to the second temperature control chamber 112. The electrical component 8 and/or the electronic components 9 are in this case connected in a thermally conductive manner to the second inner face 192. As a consequence, a reliable temperature control procedure is possible.

Furthermore, also apparent in FIG. 6 are possible connecting elements 22 that are embodied as screw-connection points 220 so as to connect to the third housing element 4.

In addition, FIG. 5 also illustrates that the second housing element 3 has a receiving facility 24 for a sealing element 133 that is not illustrated in FIG. 5. As a consequence, it is possible to seal the second temperature control chamber 112 in a reliable manner.

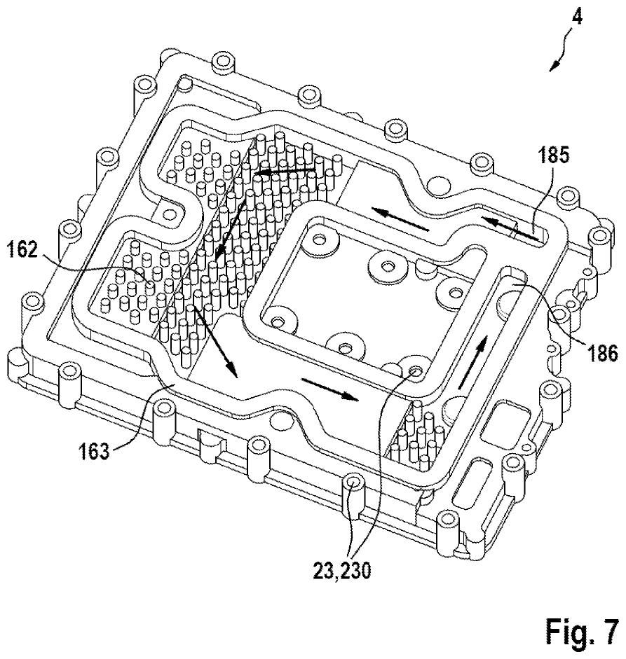

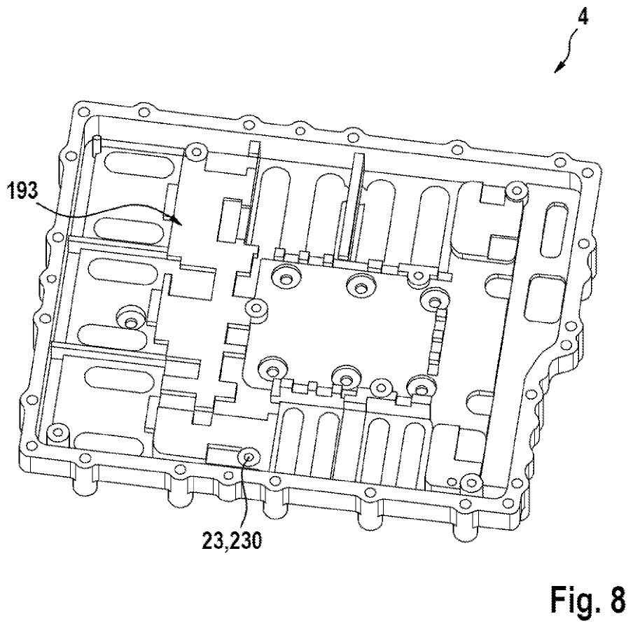

FIG. 7 illustrates in a perspective view a bottom view of an embodiment of a third housing element 4 of a battery 1 in accordance with the invention. Furthermore, FIG. 8 illustrates in a perspective view a plan view of the embodiment of the third housing element 4 of the battery 1 in accordance with the invention according to FIG. 7. The third housing element 4 is now described with reference to FIGS. 7 and 8 jointly.

It is initially apparent in FIG. 7 that the third housing element 4 comprises a third temperature control structure 103. By way of example the third temperature control structure 103 may comprise flow disturbing elements 162 and flow limiting elements 163. In particular, the flow may be consequently guided as indicated by the arrows in the second temperature control chamber 112.

Furthermore, it is also apparent in FIGS. 7 and 8 that the third housing element 4 comprises a first counterpart 185 to the temperature control fluid inlet 183 of the second housing element 3. In addition, the third housing element 4 comprises a second counterpart 186 to the temperature control fluid outlet of the second housing element 3.

Furthermore, possible connecting elements 23 that are embodied as screw-connection points 230 so as to connect to the second housing element 3 are also apparent in FIGS. 7 and 8.

In addition, FIG. 8 illustrates a third inner face 193 of the third housing element 4. The third inner face 193 of the third housing element 4 is arranged in this case directly adjacent to the second temperature control chamber 112. The electrical voltage convertor 12 or the DC convertor 120 is connected in this case in a thermally conductive manner to the third inner face 193.

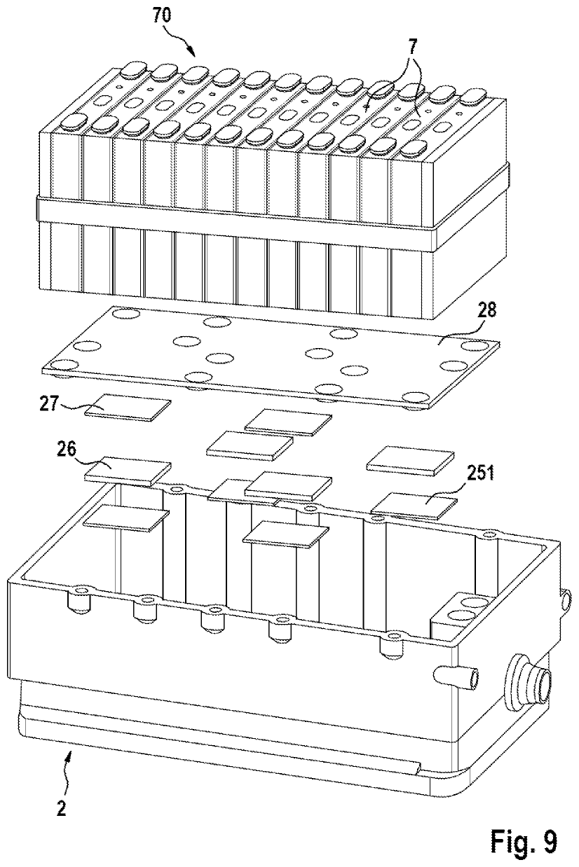

FIG. 9 illustrates in a perspective view a first exploded illustration of a section of a battery 1 in accordance with the invention.

In this case, the first housing element 2 is apparent. Furthermore, the plurality of battery cells 7 that are connected in an electrically conductive manner in series and/or in parallel to one another is apparent, said battery cells being arranged in the inner chamber 5.

The plurality of battery cells 7 may in this case by way of example also be clamped together.

Furthermore, a first thermal compensating element 251 may be arranged between the plurality of battery cells 7 and the first housing element 2.

In addition, FIG. 9 illustrates an embodiment in which additional Peltier elements 26 are arranged. The Peltier elements 26 are connected to a heat distributing plate 28 by means of a thermally conductive adhesive material 27. The heat distributing plate 28 is used so as uniformly to distribute heat that is discharged from the plurality of battery cells 7 in order consequently to produce a uniform discharge of heat. By way of example, the heat distributing plate 28 may be connected by screws to the first housing element 2. The plurality of battery cells 7 may be connected, by way of example also adhered, to the heat distributing plate 28.

The first thermal compensating element 251 is arranged between the Peltier elements 26 and the first housing element 2.

Peltier elements 26 represent a type of electrically driven heat pump. In so doing, energy in the form of heat is transmitted from one side to the other side and may be discharged there. The Peltier element 26 is based on the so-called Peltier effect which states that energy in the form of heat may be transported by a current flow in a semi-conductor. As a consequence, there is a temperature difference on both sides. The Peltier element 26 therefore represents quasi a heat pump that is based on the transport means of electrical current in a semi-conductor.

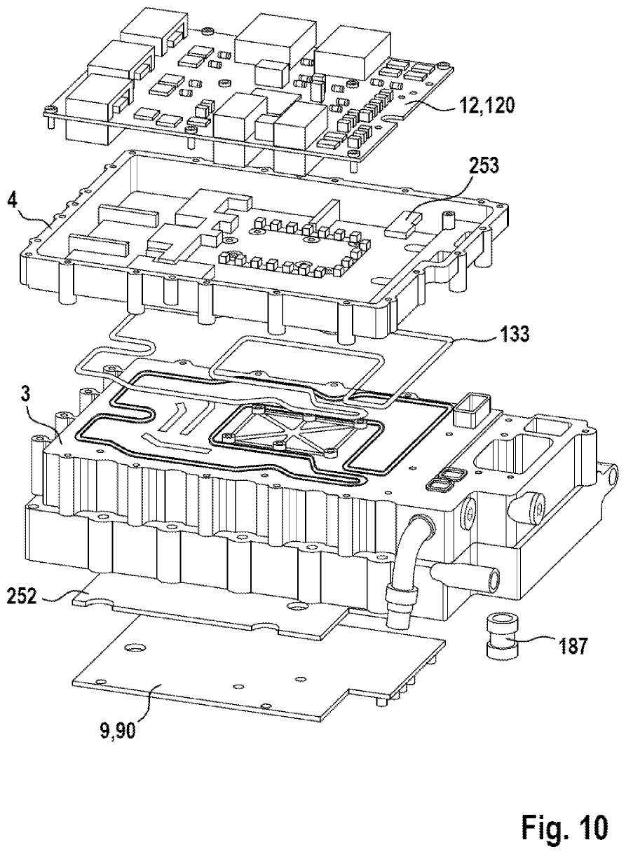

FIG. 10 illustrates in a perspective view a second exploded illustration of a section of a battery 1 in accordance with the invention.

In this case, the second housing element 3 and the third housing element 4 are apparent. Furthermore, the third sealing element 133 is apparent which is arranged between the second housing element 3 and the third housing element 4. In addition, FIG. 10 also illustrates the electrical component 8 or the electronic component 9 which is integrated by way of example into a circuit board 90. Moreover, the electrical voltage convertor 12 that is embodied by way of example as a DC convertor 120 is also apparent in FIG. 10.

Furthermore, a second thermal compensating element 252 may be arranged between the electrical component 8 and/or the electronic component 9 or the circuit board 10 and the second housing element 3.

Furthermore, a third thermal compensating element 253 may be arranged between the electrical voltage convertor 12 or rather the DC convertor 120 and the third housing element 4.

In addition, FIG. 10 also illustrates a connecting piece 187 that is used so as to connect in a fluid-conducting manner a temperature control fluid inlet 181, 183 to a corresponding temperature control fluid outlet 182, 184 with the result that a series through-flow arrangement of the first temperature control chamber 111 and the second temperature control chamber 112 is formed.

1. A battery comprising
a first housing element (2) and a second housing element (3), which jointly form an inner chamber (5),
a battery module (6) including a plurality of battery cells (7), the battery module (6) being arranged in the inner chamber (5), said battery cells being connected in an electrically conductive manner in series and/or in parallel to one another, and
a first element of a battery control system, the first element being arranged in the inner chamber (5),
wherein the first housing element (2) forms a first temperature control structure (101) on a face that is remote from the inner chamber (5),
wherein the second housing element (3) is connected to a third housing element on a face that is remote from the inner chamber (5) while forming a second temperature control chamber (112) through which temperature control fluid may flow, and
wherein the third housing element (4) receives a second element of the battery control system.

2. The battery according to claim 1, characterized in that the first element of the battery control system comprises at least one electrical component (8) and/or at least one electronic component (9) of the battery module (6) and that the second element of the battery control system is an electrical voltage convertor (12).

3. The battery according to claim 1, characterized in that the second element of the battery control system comprises at least one electrical component (8) and/or at least one electronic component (9) of the battery module (6) and that the second element of the battery control system is an electrical voltage convertor (12).

4. The battery according to claim 1, characterized in that the first housing element (2), the second housing element (3) and/or the third housing element (4) are each embodied as die-cast housings (20, 30, 40).

5. The battery according to claim 1, characterized in that the first housing element (2) and the second housing element (3) are connected in a fluid-tight manner to one another.

6. The battery according to claim 1, characterized in that the plurality of battery cells (7) is embodied as prismatic battery cells (70).

7. The battery according to claim 2, characterized in that the electrical component (8) of the battery module (6) is a cell connector (80) and/or a cable and that the at least one electronic component (9) of the battery module (6) is a switch, a safety element, a battery control system and/or a resistor.

8. The battery according to claim 2, characterized in that the at least one electronic component (9) is integrated into a circuit board (90).

9. The battery according to claim 1, characterized in that a covering element (14) is arranged on the first housing element (2) while jointly with the first temperature control structure (101) forming a first temperature control chamber (111) through which temperature control fluid may flow.

10. The battery according to the preceding claim 9, characterized in that the battery (1) comprises a first connection (151) that is configured to convey temperature control fluid to the battery (1) and a second connection (152) that is configured to discharge temperature control fluid from the battery (1), wherein the battery (1) has temperature control fluid ducts that are configured in such a manner that temperature control fluid may flow through the first temperature control (111) and the second temperature control chamber (112) in series or in parallel.

11. The battery according to claim 1, characterized in that the covering element (14) is connected to the first housing element (2) in a material-bonded manner.

12. The battery according to claim 1, the second housing element (3) forms a second temperature control structure (102) and/or the third housing element (4) forms a third temperature control structure (103).

13. The battery according to claim 1, characterized in that the first temperature control structure (101), the second temperature control structure (102) and/or the third temperature control structure (103) are each embodied as flow guiding elements (161), as flow disturbing elements (162) and/or as flow limiting elements (163).

14. The battery according to claim 1, characterized in that the plurality of battery cells (7) is connected in a thermally conductive manner to a first inner face (191) of the inner chamber (5), said first inner face being arranged directly adjacent to the first temperature control structure (101), the electrical component (8) and/or the electronic component (9) is/are arranged in a thermally conductive manner to a second inner face (192) of the inner chamber (5), said second inner face being arranged directly adjacent to the second temperature control chamber (112) and/or the electrical voltage convertor (12) is arranged in a thermally conductive manner to a third inner faces (193) of the third housing element (4), said third inner face being arranged directly adjacent to the second temperature control chamber (112).

15. (canceled)

16. The battery according to claim 3, characterized in that the electrical component (8) of the battery module (6) is a cell connector (80) and/or a cable and that the at least one electronic component (9) of the battery module (6) is a switch, a safety element, a battery control system and/or a resistor.

17. The battery according to claim 3, characterized in that the at least one electronic component (9) is integrated into a circuit board (90).

18. The battery according to claim 1, wherein the face on which the first housing element (2) forms a first temperature control structure (101) is remote from the second housing element (3), and wherein the face on which the second housing element (3) is connected to a third housing element is remote from the first housing element (2).

19. The battery according to claim 1, characterized in that the first element of the battery control system comprises at least one electrical component (8) and/or at least one electronic component (9) of the battery module (6) and that the second element of the battery control system is a DC convertor (120).

20. The battery according to claim 1, characterized in that the second element of the battery control system comprises at least one electrical component (8) and/or at least one electronic component (9) of the battery module (6) and that the second element of the battery control system is a DC convertor (120).

21. The battery according to claim 1, characterized in that the first housing element (2) and the second housing element (3) are connected in a fluid-tight manner to one another, wherein a first sealing element (131) is arranged between the first housing element (2) and the second housing element (3).

22. The battery according to claim 1, characterized in that the covering element (14) is connected to the first housing element (2) in a material-bonded manner, wherein furthermore a second sealing element (132) is arranged between the first housing element (2) and the covering element (14) or that the covering element (14) is formed by the first housing element (2).

23. The battery according to claim 1, the second housing element (3) forms a second temperature control structure (102) and/or the third housing element (4) forms a third temperature control structure (103), wherein a third sealing element (133) is arranged between the second housing element (3) and the third housing element (4).
